(19) United States
(12) Patent Application Publication
(10) Pub. No.: US 2023/0267756 A1
(43) Pub. Date: Aug. 24, 2023

(54) HANDWRITING RECOGNITION METHOD AND APPARATUS

(71) Applicant: BEIJING SOGOU TECHNOLOGY DEVELOPMENT CO., LTD., Beijing (CN)

(72) Inventors: Xiaozhe XIN, Beijing (CN); Bo QIN, Beijing (CN); Zhiyong ZHAO, Beijing (CN); Yingjun WANG, Beijing (CN); Jie WANG, Beijing (CN); Xuefeng SU, Beijing (CN); Wei CHEN, Beijing (CN)

(73) Assignee: BEIJING SOGOU TECHNOLOGY DEVELOPMENT CO., LTD., Beijing (CN)

(21) Appl. No.: 18/138,376

(22) Filed: Apr. 24, 2023

Related U.S. Application Data
(63) Continuation of application No. PCT/CN2021/103279, filed on Jun. 29, 2021.

(30) Foreign Application Priority Data
Dec. 31, 2020 (CN) 202011640989.4

(51) Int. Cl. G06V 30/32; G06V 30/19

(52) U.S. Cl. CPC G06V 30/36; G06V 30/347; G06V 30/19147

(57) ABSTRACT

A handwriting recognition method is provided, which includes: obtaining handwritten original trajectory data in real-time; compressing the handwritten original trajectory data, to obtain compressed handwritten trajectory data; and inputting the compressed handwritten trajectory data into a compressed handwriting recognition model for recognition, to obtain a text recognition result corresponding to the handwritten original trajectory data. A handwriting recognition model is obtained by training with handwritten trajectory data of each piece of training data in a training data set, and the compressed handwriting recognition model is obtained by performing model compression on the handwriting recognition model. The handwriting recognition method can address the problem in the related art that the handwriting recognition accuracy is low caused by incorrect segmentation, thereby effectively improving the handwriting recognition accuracy.

### RELATED APPLICATION

This application is a continuation application of PCT Patent Application No. PCT/CN2021/103279, filed on Jun. 29, 2021, which claims priority to Chinese Patent Application No. 202011640989.4, entitled “HANDWRITING RECOGNITION METHOD AND APPARATUS, ELECTRONIC DEVICE AND MEDIUM” filed with the Chinese Patent Office on Dec. 31, 2020, wherein the content of the of the above-referenced applications is incorporated herein by reference in its entirety.

### FIELD OF THE TECHNOLOGY

The present disclosure relates to the field of Internet technologies, and specifically to a handwriting recognition method and apparatus, an electronic device, and a medium.

### BACKGROUND OF THE DISCLOSURE

As Internet technologies rapidly advance, various input modes, such as voice input, handwriting input, pinyin input, and the like, are provided to facilitate user input. In a case of the handwriting input, handwritten input data is recognized by a handwriting recognition model, which improves the recognition efficiency, thereby enhancing the user experience.

However, a handwriting recognition framework used to recognize handwritten data in the related art is generally based on a three-stage architecture of segmentation, combination and recognition. When using the handwriting recognition framework for recognition, especially for recognizing continuous stroke inputs, such as continuous stroke cursive handwriting, continuous stroke running handwriting, and the like, since there is no pause during the continuous stroke handwriting, a segmentation module has a high probability of incorrect segmentation, resulting in low recognition accuracy.

### SUMMARY

The present disclosure provides a handwriting recognition method and apparatus, an electronic device, and a medium, which addresses the problem in the related art that the handwriting recognition accuracy is low caused by incorrect segmentation, thereby effectively improving the handwriting recognition accuracy.

A first aspect of the present disclosure is to provide a handwriting recognition method, including: obtaining handwritten original trajectory data in real-time; compressing the handwritten original trajectory data, to obtain compressed handwritten trajectory data; and inputting the compressed handwritten trajectory data into a compressed handwriting recognition model for recognition, to obtain a text recognition result corresponding to the handwritten original trajectory data. A handwriting recognition model is obtained by training with handwritten trajectory data of each piece of training data in a training data set, and the compressed handwriting recognition model is obtained by performing model compression on the handwriting recognition model.

A second aspect of the present disclosure is to provide a handwriting recognition apparatus, including: a memory operable to store computer-readable instructions and a processor circuitry operable to read the computer-readable instructions. When executing the computer-readable instructions, the processor circuitry is configured to: obtain handwritten original trajectory data in real-time; compress the handwritten original trajectory data, to obtain compressed handwritten trajectory data; and input the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

A third aspect of the present disclosure is to provide a non-transitory machine-readable media having instructions stored on the machine-readable media. The instructions are configured to, when executed, cause a machine to: obtain handwritten original trajectory data in real-time; compress the handwritten original trajectory data, to obtain compressed handwritten trajectory data; and input the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

Based on the foregoing technical solutions, after obtaining the handwritten original trajectory data in real-time, the handwritten original trajectory data is compressed. The obtained compressed handwritten trajectory data is used as the input, and the handwritten sequence features of the compressed handwritten trajectory data are recognized by the compressed end-to-end model, to obtain the text recognition result. Compared with the segmentation, combination and recognition in the related art, when recognizing continuous stroke inputs, such as continuous stroke cursive handwriting, continuous stroke running handwriting, and the like, since there is no pause during the continuous stroke handwriting, the segmentation module has a high probability of incorrect segmentation, resulting in low recognition accuracy. However, the use of the compressed handwriting recognition model avoids the segmentation module which conducts incorrect segmentation. The compressed handwritten trajectory data obtained by compressing the handwritten original trajectory data is used as the input, and the handwritten sequence features are used for recognition, which effectively avoids the problem in the related art that the recognition accuracy is low caused by incorrect segmentation, thereby effectively improving the recognition accuracy.

### BRIEF DESCRIPTION OF THE DRAWINGS

FIG. 1 is a flowchart of a handwriting recognition method according to one or more embodiments of the present disclosure.

FIG. 2 is a flowchart of a training method for a handwriting recognition model according to one or more embodiments of the present disclosure.

FIG. 3 is a schematic structural diagram of a handwriting recognition apparatus according to one or more embodiments of the present disclosure.

FIG. 4 is a structural diagram of a handwriting recognition apparatus as a device according to one or more embodiments of the present disclosure.

FIG. 5 is a structural diagram of a server according to one or more embodiments of the present disclosure.

### DESCRIPTION OF EMBODIMENTS

In order to better understand the foregoing technical solutions, the accompanying drawings and specific embodiments are used to explain the technical solutions of the present disclosure in detail. The present disclosure and the specific features in the embodiments are detailed description of the technical solutions, but not the limitation of them. The present disclosure and the specific features in the embodiments may be combined with each other.

In view of the technical problem that responding with expression pictures results in low efficiency, the present disclosure provides a handwriting recognition method, including: obtaining handwritten original trajectory data in real-time; and inputting the handwritten original trajectory data into a preset handwriting recognition model for recognition, to obtain a text recognition result corresponding to the handwritten original trajectory data. The handwriting recognition model is obtained by training with handwritten trajectory data of each piece of training data in a training data set.

After obtaining the handwritten original trajectory data in real-time, the handwritten original trajectory data is compressed. The obtained compressed handwritten trajectory data is used as the input, and the handwritten sequence features of the compressed handwritten trajectory data are recognized by the compressed end-to-end model, to obtain the text recognition result. Compared with the segmentation, combination and recognition in the related art, when recognizing continuous stroke inputs, such as continuous stroke cursive handwriting, continuous stroke running handwriting, and the like, since there is no pause during the continuous stroke handwriting, the segmentation module has a high probability of incorrect segmentation, resulting in low recognition accuracy. However, the use of the compressed handwriting recognition model avoids the segmentation module which conducts incorrect segmentation. The compressed handwritten trajectory data obtained by compressing the handwritten original trajectory data is used as the input, and the handwritten sequence features are used for recognition, which effectively avoids the problem in the related art that the recognition accuracy is low caused by incorrect segmentation, thereby effectively improving the recognition accuracy.

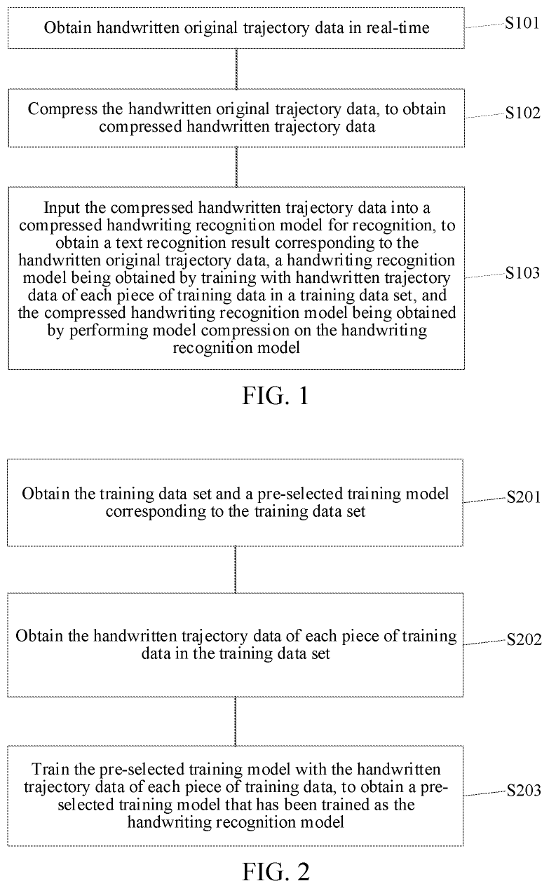

As shown in FIG. 1, the present disclosure provides a handwriting recognition method, including the following steps:

S101. Obtain handwritten original trajectory data in real-time.

S102. Compress the handwritten original trajectory data, to obtain compressed handwritten trajectory data.

S103. Input the compressed handwritten trajectory data into a compressed handwriting recognition model for recognition, to obtain a text recognition result corresponding to the handwritten original trajectory data. A handwriting recognition model is obtained by training with handwritten trajectory data of each piece of training data in a training data set, and the compressed handwriting recognition model is obtained by performing model compression on the handwriting recognition model.

According to some embodiments of the present disclosure, in step S101, the handwritten original trajectory data may be obtained in real-time according to handwritten input data written by a user on a display screen of an electronic device. For example, after the user makes each stroke on the display screen, handwritten original trajectory data of each stroke is obtained according to the handwritten input data of each stroke, which ensures that the obtained handwritten original trajectory data is real time.

According to some embodiments of the present disclosure, the electronic device may be, for example, a smart phone, a tablet computer, a notebook computer, an e-book reader, or the like; further, the display screen may be, for example, a liquid crystal display (LCD) screen, a light-emitting diode (LED) screen, an electronic ink screen, or the like, which is not specifically limited herein.

According to some embodiments of the present disclosure, the handwritten input data may include trajectory data written by a user with an electronic pen and trajectory data written by a user with a finger, which is not specifically limited herein.

When obtaining the handwritten original trajectory data in real-time, data preprocessing may be performed on the handwritten input data that is obtained in real-time, the data preprocessing including re-sampling; and the handwritten original trajectory data is obtained in real-time according to the handwritten input data after the preprocessing. The data preprocessing may further include trajectory rotation, or may include re-sampling and trajectory rotation, or may include re-sampling, trajectory rotation, and trajectory cleaning. After obtaining the handwritten original trajectory data, the handwritten original trajectory data is compressed, to obtain the compressed handwritten trajectory data.

According to some embodiments of the present disclosure, the data preprocessing generally includes re-sampling and trajectory rotation, so that when obtaining the handwritten original trajectory data in real-time according to the handwritten input data after the preprocessing, the precision of the handwritten original trajectory data is enhanced.

According to some embodiments of the present disclosure, in order to address the problem that acquisition frequencies of trajectory points are different due to that users write on different electronic devices or have different handwriting speeds, the re-sampling is performed on the handwritten input data, so as to remove redundant points in the handwritten input data. In this case, the re-sampling may include angle-based re-sampling or distance-based re-sampling, or include the angle-based re-sampling and the distance-based re-sampling. For example, the redundant points may be removed based on set conditions such as the cos included angle being less than 20 or 30 degrees, and/or, the distance being less than 4, 5, or 6 pixels. After the redundant points are removed, the handwritten input data only retains handwritten skeleton information. Since the handwritten input data only retains the handwritten skeleton information, with interference information being removed, the precision of the handwritten original trajectory data that is obtained in real-time is enhanced, thereby improving the recognition accuracy in the subsequent recognition.

In addition, in order to address the problem that the recognition accuracy of the handwritten original trajectory data is low caused by users' irregular handwriting, the trajectory rotation may be performed on the handwritten input data. In this case, the handwritten input data may be rotated by plus or minus 15 degrees, plus or minus 20 degrees, or the like, and the re-sampling is performed on the trajectory data after the rotation, to obtain the handwritten input data after the preprocessing as the handwritten original trajectory data. In this way, the interference information is removed from the handwritten original trajectory data, and also the problem that the recognition accuracy is low caused by users' irregular handwriting can be avoided, thereby enhancing the precision of the handwritten original trajectory data. The users' irregular handwriting includes oblique writing, upward writing, and the like.

After obtaining the handwritten original trajectory data in real-time, step S102 is performed.

In step S102, after obtaining the handwritten original trajectory data in real-time, when compressing the handwritten original trajectory data, dimensional compression may be performed on the handwritten original trajectory data, to obtain the compressed handwritten trajectory data. A correlation between data of each dimension in the compressed handwritten trajectory data and a model recognition result of the handwriting recognition model is not lower than a predetermined threshold. In addition, feature selection may be performed on the handwritten original trajectory data, to obtain the compressed handwritten trajectory data.

According to some embodiments of the present disclosure, the dimensionality reduction technique such as principal component analysis (PCA) may be adopted to search main features that can represent original features of the handwritten original trajectory data, so as to ensure that the correlation between the retained data of each dimension and the model recognition result is not lower than the predetermined threshold. The compressed handwritten trajectory data is obtained according to the retained data of each dimension. The predetermined threshold may be configured according to an actual requirement. For example, K features having highest correlations with the model recognition result may be selected to be retained, and the predetermined threshold may be configured according to the feature in the K features whose correlation is the lowest, K being an integer not less than 2.

Since the correlation between the data of each dimension in the compressed handwritten trajectory data and the model recognition result is not lower than the predetermined threshold, the compressed handwritten trajectory data includes the main features representing the original features of the handwritten original trajectory data. In this way, the recognition accuracy is ensured when the compressed handwritten trajectory data is input into the compressed handwriting recognition model for recognition.

According to some embodiments of the present disclosure, after the dimensional compression is performed on the handwritten original trajectory data to obtain the compressed handwritten trajectory data, during the subsequent process of using the compressed handwriting recognition model for recognition, through the feature selection, the unit dimension of hidden layers in the compressed handwriting recognition model is greatly reduced, for example, the dimension is reduced from 512 to 256 or 128. In a case that the dimension is reduced, the computational efficiency is significantly improved, thereby improving the real-time performance of the compressed handwriting recognition model.

After obtaining the compressed handwritten trajectory data, step S103 is performed.

Before performing step S103, the handwriting recognition model needs to be trained in advance, and then the model compression is performed on the handwriting recognition model that has been trained, to obtain the compressed handwriting recognition model. In addition, after the handwriting recognition model has been trained, the compressed handwritten trajectory data is input into the compressed handwriting recognition model for recognition, to obtain the text recognition result. The handwriting recognition model is obtained by training with the handwritten trajectory data of each piece of training data in the training data set, and the compressed handwriting recognition model is obtained by performing the model compression on the handwriting recognition model.

According to some embodiments of the present disclosure, the handwriting recognition model is an end-to-end model, so that an input of the handwriting recognition model is the compressed handwritten trajectory data, and an output is the text recognition result, which can effectively overcome the defect in the related art that a plurality of modules are used for recognition.

Since the handwriting recognition model is obtained by training with the handwritten trajectory data of each piece of training data in the training data set, and the compressed handwritten trajectory data is obtained by performing dimensional compression on the handwritten original trajectory data, it can be ensured that the compressed handwritten trajectory data maintains a high similarity with the trained handwritten trajectory data, thereby effectively improving the recognition accuracy when the compressed handwritten trajectory data is input into the handwriting recognition model for recognition. In addition, since the correlation between the data of each dimension in the compressed handwritten trajectory data and the model recognition result is not lower than the predetermined threshold, the compressed handwritten trajectory data includes the main features representing the original features of the handwritten original trajectory data, which ensures the recognition accuracy when the compressed handwritten trajectory is input into the compressed handwriting recognition model for recognition.

According to some embodiments of the present disclosure, when training the handwriting recognition model, as shown in FIG. 2, the training of the handwriting recognition model includes the following steps:

S201. Obtain the training data set and a pre-selected training model corresponding to the training data set.

S202. Obtain the handwritten trajectory data of each piece of training data in the training data set.

S203. Train the pre-selected training model with the handwritten trajectory data of each piece of training data, to obtain the pre-selected training model that has been trained as the handwriting recognition model.

In step 201, handwritten trajectory data of a large number of users may be acquired, and all or a part of the acquired handwritten trajectory data is used as the training data set. In addition, a model is selected from at least one model whose recognition accuracy for the training data set is greater than a predetermined threshold as the pre-selected training model. Typically, the model with the highest recognition accuracy is selected as the pre-selected training model. Alternatively, the model with the second highest or the third highest recognition accuracy may be selected as the pre-selected training model. For example, after obtaining the training data set, the recognition accuracies of existing models A1, A2, A3 and A4 for the training data set are 85%, 70%, 65% and 92% respectively. If the predetermined threshold is 75%, since 92%>85%>75%, a model may be selected from A1 and A4 as the pre-selected training model in different manners. In order to shorten the time of a subsequent training process, A4 with the highest recognition accuracy may be selected as the pre-selected training model.

According to some embodiments of the present disclosure, when obtaining the training data set, a historical handwritten trajectory data set may be obtained. The historical handwritten trajectory data set includes one or more of horizontal handwritten trajectory data, vertical handwritten trajectory data, overlapping handwritten trajectory data, and rotating handwritten trajectory data. A part or all of data in the obtained historical handwritten trajectory data set may be used as the training data set.

According to some embodiments of the present disclosure, various types of data, such as 5 or 6 types of data, may be generated by a program, to simulate real-world writing scenes, including horizontal writing, vertical writing, overlapping writing, rotating writing, and the like, so as to generate the horizontal handwritten trajectory data, the vertical handwritten trajectory data, the overlapping handwritten trajectory data, and the rotating handwritten trajectory data. The historical handwritten trajectory data is obtained according to the horizontal handwritten trajectory data, the vertical handwritten trajectory data, the overlapping handwritten trajectory data, and the rotating handwritten trajectory data.

According to some embodiments of the present disclosure, when obtaining the historical handwritten trajectory data set, data augmentation may be performed on the handwritten data in the historical handwritten trajectory data set, and the historical handwritten trajectory data set after the data augmentation is used as the training data set, so that the training data set has more and richer training data. Based on the more and richer training data, the training effect of the model can be enhanced, thereby improving the accuracy of the handwriting recognition model that has been trained with the training data.

After obtaining the training data set, step S202 is performed.

In step S202, data preprocessing may be performed on each piece of training data in the training data set; and the handwritten trajectory data of each piece of training data may be obtained according to each piece of training data after the preprocessing. The data preprocessing includes at least one of re-sampling and trajectory rotation. In this case, the data preprocessing may include re-sampling or trajectory rotation, or may include re-sampling and trajectory rotation, or may include re-sampling, trajectory rotation, and trajectory cleaning.

According to some embodiments of the present disclosure, the data preprocessing generally includes re-sampling and trajectory rotation, so that when the handwritten trajectory data of each piece of training data is obtained according to each piece of training data after the preprocessing, the precision of the handwritten trajectory data of each piece of training data can be enhanced.

According to some embodiments of the present disclosure, the specific implementation of step S202 may refer to the description of step S102, which is not detailed herein for the sake of simplicity.

After obtaining the handwritten trajectory data of each piece of training data, step S203 is performed.

In step S203, when training the pre-selected training model with the handwritten trajectory data of each piece of training data, a difficult sample is first trained and an easy sample is then trained. In addition, the pre-selected training model may be fine-tuned in the training process. Finally, a model satisfying a constraint condition is obtained as the pre-selected training model that has been trained, and the pre-selected training model that has been trained is used as the handwriting recognition model.

According to some embodiments of the present disclosure, first, a difficult sample and an easy sample in each piece of training data may be obtained; then, the pre-selected model is trained in a mode of first training the difficult sample and then training the easy sample. During the process of training the pre-selected model, the pre-selected training model is fine-tuned, to obtain the pre-selected training model that has been trained, and the pre-selected training model that has been trained is used as the handwriting recognition model.

According to some embodiments of the present disclosure, the pre-selected training model may be a gated recurrent unit (GRU) neural network, a long short-term memory (LS™) network, an attention network, an encoder-decoder network, a quasi-recurrent neural network (QRNN).

According to some embodiments of the present disclosure, when fine-tuning the pre-selected training model during the training process, the network in the pre-selected training model may be adjusted to a combination of a network that extracts a Bessel feature and a QRNN network or a combination of a network that extracts a Bessel feature and a GRU network, the difference between which lies in that the recognition speed of the QRNN structure is faster. Another example is a combination of a network that extracts a differential feature and a BLS™ network or a combination of the original trajectory, a one-dimensional convolution layer and a BLS™ network, the difference between which lies in that the latter is additionally provided with the convolution layer to extract the feature, thereby having a better effect but with higher time cost.

When fine-tuning the pre-selected training model during the training process, the network in the pre-selected training model may be adjusted to a combination of a GRU/LS™ network and a fully connected (FC) layer, or a combination of an attention network and an encoder-decoder network, which is not specifically limited herein.

In this way, when fine-tuning the pre-selected training model in the training process, other network may be used to replace the network in the pre-selected training model, so as to obtain a better network more quickly. This shortens the fine-tuning time, thereby improving the training efficiency. Further, the model that meets the constraint condition can be trained more quickly as the pre-selected training model that has been trained, and the pre-selected training model that has been trained is used as the handwriting recognition model.

According to some embodiments of the present disclosure, the constraint condition may include at least one of conditions that the recognition accuracy is greater than the set accuracy, the precision is greater than a set precision, a recall rate is greater than a set recall rate, and a loss function solution.

When obtaining the training data set, the data augmentation is performed on the handwritten data in the historical handwritten trajectory data set, which makes the training data set have more and richer training data. In addition, when training the pre-selected training model, the mode of first training the difficult sample and then training the easy sample is adopted, and the fine-tuning is performed during the training process. Since the mode of first training the difficult sample and then training the easy sample is adopted, on the basis of improving the accuracy of the model to recognize difficult samples, the accuracy of the model to recognize easy samples can be improved through the subsequent fine-tuning, thereby improving the recognition accuracy of the finally obtained end-to-end model. That is, the recognition accuracy for difficult samples can be improved on the basis of ensuring the recognition accuracy for easy samples.

In this way, in step S103, after obtaining the compressed handwritten trajectory data in real-time, the compressed handwritten trajectory data is input into the end-to-end handwriting recognition model obtained by training in step S201 to step S203 for recognition, and a recognized text is used as the text recognition result. The end-to-end handwriting recognition model obtained by training in step S201 to step S203 improves the recognition accuracy for difficult samples on the basis of ensuring the recognition accuracy for easy samples, thereby improving the accuracy of the text recognition result after inputting the compressed handwritten trajectory data.

According to some embodiments of the present disclosure, after obtaining the pre-selected training model that has been trained through training in step S201 to step S203, it is further necessary to perform model compression on the pre-selected training model that has been trained, to obtain the pre-selected training model after the compression, and the pre-selected training model after the compression is used as the compressed handwriting recognition model. In this way, when performing step S103, the compressed handwritten trajectory data is input into the pre-selected training model after the compression for recognition, to obtain the text recognition result.

Since the compressed handwritten trajectory data is obtained by performing dimensional compression on the handwritten original trajectory data, during the subsequent process of using the compressed handwriting recognition model for recognition, through the feature selection, the unit dimension of hidden layers in the compressed handwriting recognition model is greatly reduced, for example, the dimension is reduced from 512 to 256 or 128. When the dimension is reduced, the computational efficiency is significantly improved, thereby improving the real-time performance of the compressed handwriting recognition model.

According to some embodiments of the present disclosure, the model compression includes quantization (linear quantization and nonlinear quantization), distillation, pruning (structured and unstructured), network architecture search (NAS) and matrix decomposition. In this way, the model compression may be performed on the pre-selected training model that has been trained, so that the pre-selected training model after the compression is made smaller, and accordingly the end-to-end model is made smaller, which reduces the calculation amount and saves storage space, thereby meeting a requirement for deployment to a mobile terminal.

According to some embodiments of the present disclosure, the model compression is preferably model distillation. In this case, the model distillation may be performed on the pre-selected training model that has been trained, to obtain the pre-selected training model after the distillation. The pre-selected training model after the distillation is used as the compressed handwriting recognition model. Then, the compressed handwritten trajectory data is input into the compressed handwriting recognition model for recognition, to obtain the text recognition result.

According to some embodiments of the present disclosure, the model distillation may include feature-based distillation, logits-based distillation, relationship-based distillation, and the like. After the distillation, the size of model parameters may be decreased from 8 Mbyte to 3 Mbyte, while the accuracy is not reduced. In this way, the end-to-end model is made smaller, with no reduction in the recognition accuracy. After the model distillation is performed, non-linear quantization processing may be performed. If the model with the 3-Mbyte parameter size is stored in a mobile terminal, and each parameter is stored as float type, the model size is 3 Mbytex4 byte=12 Mbyte, which generally exceeds the conventional storage of the mobile terminal. After the non-linear quantization processing, the model parameters may be stored as int8 type, that is, the final storage size is 3 Mbyte×1 byte=3 Mbyte, which can meet the requirement for deployment to the mobile terminal. In this way, the small model with low complexity but basically unchanged accuracy after the distillation is used as the compressed handwriting recognition model.

For example, the pre-selected training model that has been trained is a complex model, specifically a four-layer bidirectional LSTM+2FC+CTC LOSS. The complex model is undergone the distillation using the distillation method based on logits, to obtain a small model of a two-layer unidirectional LSTM+1FC+CTC LOSS. As such the size of parameters is decreased by more than one half, and accordingly the calculation amount is reduced. This allows each model prediction to be made for each stroke, thereby realizing real-time streaming output.

In this way, since the compressed handwritten trajectory data is obtained by performing the dimensional compression on the handwritten original trajectory data, during the subsequent process of using the compressed handwriting recognition model for recognition, through the feature selection, the unit dimension of the hidden layers in the compressed handwriting recognition model is greatly reduced, and the size of model parameters in the compressed handwriting recognition model is decreased. When the unit dimension of the hidden layers is greatly reduced and the size of model parameters is decreased, the computational efficiency of the compressed handwriting recognition model is improved, thereby ensuring the real-time performance of the recognition.

Based on the foregoing technical solutions, after obtaining the handwritten original trajectory data in real-time, the handwritten original trajectory data is compressed. The obtained compressed handwritten trajectory data is used as the input, and the handwritten sequence features of the compressed handwritten trajectory data are recognized by the compressed end-to-end model, to obtain the text recognition result. Compared with the segmentation, combination and recognition in the related art, when recognizing continuous stroke inputs, such as continuous stroke cursive handwriting, continuous stroke running handwriting, and the like, since there is no pause during the continuous stroke handwriting, the segmentation module has a high probability of incorrect segmentation, resulting in low recognition accuracy. However, the use of the compressed handwriting recognition model avoids the segmentation module which conducts incorrect segmentation. The compressed handwritten trajectory data obtained by compressing the handwritten original trajectory data is used as the input, and the handwritten sequence features are used for recognition, which effectively avoids the problem in the related art that the recognition accuracy is low caused by incorrect segmentation, thereby effectively improving the recognition accuracy.

Moreover, since the compressed handwritten trajectory data is obtained by performing the dimensional compression on the handwritten original trajectory data, during the subsequent process of using the compressed handwriting recognition model for recognition, through the feature selection, the unit dimension of the hidden layers in the compressed handwriting recognition model is greatly reduced, and the size of model parameters in the compressed handwriting recognition model is decreased. When the unit dimension of the hidden layers is greatly reduced and the size of model parameters is decreased, the computational efficiency of the compressed handwriting recognition model is improved, thereby ensuring the real-time performance of the recognition.

Apparatus Embodiments

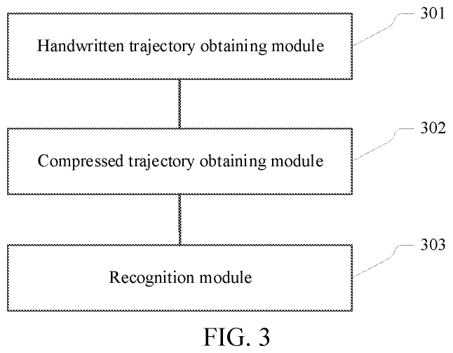

Referring to FIG. 3, it shows a schematic structural diagram of a handwriting recognition apparatus according to one or more embodiments of the present disclosure. The apparatus may include:

a handwritten trajectory obtaining module 301, configured to obtain handwritten original trajectory data in real-time;

a compressed trajectory obtaining module 302, configured to compress the handwritten original trajectory data, to obtain compressed handwritten trajectory data; and

a recognition module 303, configured to input the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

Herein, the term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

In some embodiments, the handwritten trajectory obtaining module 301 is configured to perform data preprocessing on handwritten input data that is obtained in real-time, the data preprocessing including re-sampling; and obtain the handwritten original trajectory data in real-time according to the handwritten input data after the preprocessing.

In some embodiments, the compressed trajectory obtaining module 302 is configured to perform dimensional compression on the handwritten original trajectory data, to obtain the compressed handwritten trajectory data, a correlation between data of each dimension in the compressed handwritten trajectory data and a model recognition result of the handwriting recognition model being not lower than a predetermined threshold.

In some embodiments, the handwriting recognition model is an end-to-end model.

In some embodiments, the apparatus further includes:

a model training module, configured to obtain the training data set and a pre-selected training model corresponding to the training data set; obtain the handwritten trajectory data of each piece of training data in the training data set; and train the pre-selected training model with the handwritten trajectory data of each piece of training data, to obtain the pre-selected training model that has been trained as the handwriting recognition model.

In some embodiments, the model training module includes:

a training data set obtaining unit, configured to obtain a historical handwritten trajectory data set, the historical handwritten trajectory data set including one or more of horizontal handwritten trajectory data, vertical handwritten trajectory data, overlapping handwritten trajectory data, and rotating handwritten trajectory data; and perform data augmentation on handwritten data in the historical handwritten trajectory data set, and use the historical handwritten trajectory data set after the data augmentation as the training data set.

In some embodiments, the model training module includes:

a model training unit, configured to obtain a difficult sample and an easy sample in each piece of training data; train the pre-selected model in a mode of first training the difficult sample and then training the easy sample; and fine-tune the pre-selected training model during a process of training the pre-selected model, and use the pre-selected training model that has been trained as the handwriting recognition model.

In some embodiments, the apparatus further includes:

a compressed model obtaining module, configured to, after training the pre-selected training model, to obtain the pre-selected training model that has been trained as the handwriting recognition model, perform model distillation on the pre-selected training model that has been trained, to obtain the pre-selected training model after the distillation, and use the pre-selected training model after the distillation as the compressed handwriting recognition model.

The apparatus embodiments are basically similar to the method embodiments, and therefore are described briefly. The relevant parts may refer to the description in the method embodiments.

The embodiments in the present disclosure are all described in a progressive manner. Description of each embodiment focuses on differences from other embodiments, and reference may be made to each other for the same or similar parts among respective embodiments.

The specific implementations of performing operations by the various modules of the apparatus in the foregoing embodiments are described in detail in the embodiments related to the method, and are not further detailed herein.

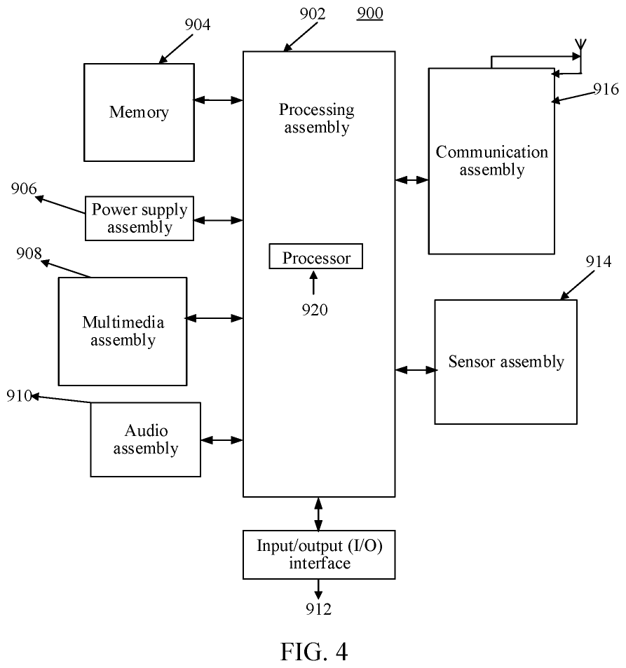

FIG. 4 is a structural diagram of a handwriting recognition apparatus as a device according to one or more embodiments of the present disclosure. For example, the apparatus 900 may be a mobile phone, a computer, a digital broadcasting terminal, a messaging device, a game console, a tablet device, a medical device, a fitness facility, a personal digital assistant, or the like.

Referring to FIG. 4, the apparatus 900 may include one or more of the following assemblies: a processing assembly 902, a memory 904, a power supply assembly 906, a multimedia assembly 908, an audio assembly 910, an input/output (I/O) interface 912, a sensor assembly 914, and a communication assembly 916.

The processing assembly 902 usually controls the whole operation of the apparatus 900, such as operations associated with displaying, a phone call, data communication, a camera operation, and a recording operation. The processing assembly 902 may include one or more processors 920 to execute instructions, to complete all or some steps of the foregoing method. In addition, the processing assembly 902 may include one or more modules, to facilitate the interaction between the processing assembly 902 and other assemblies. For example, the processing assembly 902 may include a multimedia module, to facilitate the interaction between the multimedia assembly 908 and the processing assembly 902.

The memory 904 is configured to store various types of data to support operations on the apparatus 900. Examples of the data include instructions, contact data, phonebook data, messages, pictures, videos, and the like of any application or method used to be operated on the apparatus 900. The memory 904 may be implemented by any type of volatile or non-volatile storage devices or a combination thereof, such as a static random access memory (SRAM), an electrically erasable programmable read-only memory (EPROM), a programmable read-only memory (PROM), a read-only memory (ROM), a magnetic memory, a flash memory, a magnetic disc, or an optical disc.

The power supply assembly 906 provides power to the assemblies of the apparatus 900. The power supply assembly 906 may include a power supply management system, one or more power supplies, and other assemblies associated with generating, managing and allocating power for the apparatus 900.

The multimedia assembly 908 includes a screen providing an output interface between the apparatus 900 and a user. In some embodiments, the touch display screen may include a LCD and a touch panel (TP). If the screen includes a TP, the screen may be implemented as a touchscreen, to receive an input signal from the user. The TP includes one or more touch sensors to sense touching, sliding, and gestures on the TP. The touch sensor may not only sense the boundary of touching or sliding operations, but also detect duration and pressure related to the touching or sliding operations. In some embodiments, the multimedia assembly 908 includes a front camera and/or a rear camera. When the apparatus 900 is in an operation mode, such as a shoot mode or a video mode, the front camera and/or the rear camera may receive external multimedia data. Each front camera and rear camera may be a fixed optical lens system or have a focal length and an optical zooming capability.

The audio assembly 910 is configured to output and/or input an audio signal. For example, the audio assembly 910 includes a microphone (MIC), and when the apparatus 900 is in an operation mode, such as a call mode, a recording mode, and a voice identification mode, the MIC is configured to receive an external audio signal. The received audio signal may be further stored in the memory 904 or sent through the communication assembly 916. In some embodiments, the audio assembly 910 further includes a loudspeaker, configured to output an audio signal.

The I/O interface 912 provides an interface between the processing assembly 902 and an external interface module. The external interface module may be a keyboard, a click wheel, buttons, or the like. The buttons may include, but not limited to: a homepage button, a volume button, a start-up button, and a locking button.

The sensor assembly 914 includes one or more sensors, configured to provide status evaluation in each aspect to the apparatus 900. For example, the sensor assembly 914 may detect an opened/closed status of the apparatus 900, and relative positioning of the assembly. For example, the assembly is a display and a small keyboard of the apparatus 900. The sensor assembly 914 may further detect the position change of the apparatus 900 or one assembly of the apparatus 900, the existence or nonexistence of contact between the user and the apparatus 900, the azimuth or acceleration/deceleration of the apparatus 900, and the temperature change of the apparatus 900. The sensor assembly 914 may include a proximity sensor, configured to detect the existence of nearby objects without any physical contact. The sensor assembly 914 may further include an optical sensor, such as a complementary metal oxide semiconductor (CMOS) image sensor or a charge-coupled device (CCD) image sensor, that is used in an imaging application. In some embodiments, the sensor assembly 914 may further include an acceleration sensor, a gyroscope sensor, a magnetic sensor, a pressure sensor, or a temperature sensor.

The communication assembly 916 is configured to facilitate communication in a wired or wireless manner between the apparatus 900 and other devices. The apparatus 900 may access a wireless network based on communication standards, such as Wi-Fi, 2G, or 3G, or a combination thereof. In an exemplary embodiment, the communication assembly 916 receives a broadcast signal or broadcast related information from an external broadcast management system via a broadcast channel. In an exemplary embodiment, the communication assembly 916 further includes a near field communication (NFC) module, to promote short range communication. For example, the NFC module may be implemented based on a radio frequency identification (RFID) technology, an infra-red data association (IrDA) technology, an ultra wideband (UWB) technology, a Bluetooth (BT) technology, and other technologies.

In some embodiments, the apparatus 900 may be implemented as one or more application specific integrated circuit (ASIC), a digital signal processor (DSP), a digital signal processing device (DSPD), a programmable logic device (PLD), a field programmable gate array (FPGA), a controller, a micro-controller, a microprocessor or other electronic element, so as to perform the foregoing method.

In some embodiments, a non-transitory computer readable storage medium including instructions, such as a memory 904 including instructions, is further provided, and the foregoing instructions may be executed by a processor 920 of the apparatus 900 to complete the foregoing method. For example, the non-transitory computer readable storage medium may be a ROM, a RAM, a CD-ROM, a magnetic tape, a floppy disk, an optical data storage device, or the like.

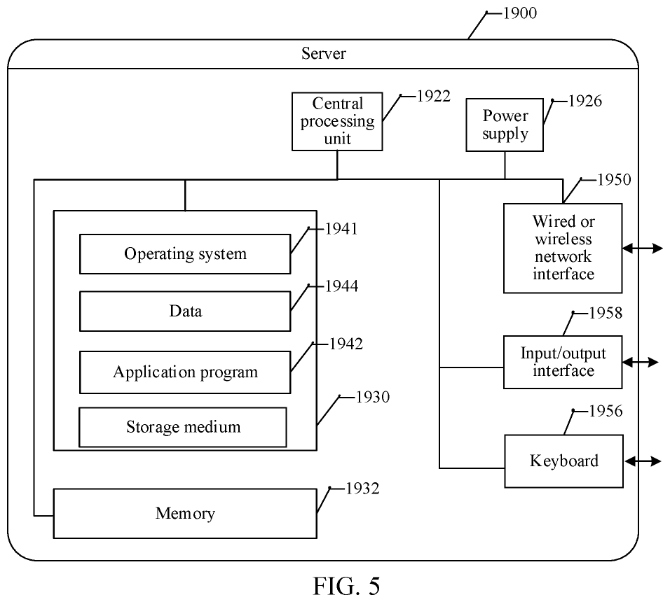

FIG. 5 is a structural diagram of a server according to some embodiments of the present disclosure. The server 1900 may greatly differ as configuration or performance differs, may include one or more central processing units (CPUs) 1922 (for example, one or more processors), a memory 1932, and one or more storage mediums 1930 storing an application program 1942 or data 1944 (for example, one or more mass storage devices). The memories 1932 and the storage mediums 1930 may be used for transient storage or permanent storage. A program stored in the storage medium 1930 may include one or more modules (which are not marked in the figure), and each module may include a series of instruction operations on the server. Further, the central processing units 1922 may be configured to communicate with the storage media 1930, and perform on the server 1900 a series of instruction operations stored in the storage media 1930.

The server 1900 may further include one or more power supplies 1926, one or more wired or wireless network interfaces 1950, one or more input/output interfaces 1958, one or more keyboards 1956, and/or, one or more operating systems 1941, for example, Windows Server™, Mac OS X™, Unix™, Linux™, and FreeBSD™.

A non-transitory computer-readable storage medium, when the instructions in the storage medium are executed by a processor of an apparatus (device or server), causes the apparatus to execute a handwriting recognition method, including: obtaining handwritten original trajectory data in real-time; compressing the handwritten original trajectory data, to obtain compressed handwritten trajectory data; and inputting the compressed handwritten trajectory data into a compressed handwriting recognition model for recognition, to obtain a text recognition result corresponding to the handwritten original trajectory data. A handwriting recognition model is obtained by training with handwritten trajectory data of each piece of training data in a training data set, and the compressed handwriting recognition model is obtained by performing model compression on the handwriting recognition model.

The present disclosure is described with reference to the flowchart and/or block diagram of the method, device (system), and computer program product of the embodiments of the present disclosure. The computer program instructions may implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more procedures in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

Although the exemplary embodiments of the present invention have been described, persons skilled in the art may make alterations and modifications to these embodiments once they learn the basic inventive concept. Therefore, the appended claims are intended to be construed as including the exemplary embodiments and all alterations and modifications falling within the scope of the present disclosure.

Apparently, persons skilled in the art may make various modifications and variations to the present disclosure without departing from the spirit and scope of the present disclosure. If these modifications and variations of the present disclosure belong to the scope of the claims of the present disclosure and equivalent technologies thereof, the present disclosure is also intended to cover these modifications and variations.

What is claimed is:

1. A handwriting recognition method, comprising:
obtaining handwritten original trajectory data in real-time;
compressing the handwritten original trajectory data, to obtain compressed handwritten trajectory data; and
inputting the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

2. The method according to claim 1, wherein the obtaining the handwritten original trajectory data in real-time comprises:
performing data preprocessing on handwritten input data that is obtained in real-time, the data preprocessing comprising re-sampling; and
obtaining the handwritten original trajectory data in real-time according to the preprocessed handwritten input data.

3. The method according to claim 2, wherein the compressing the handwritten original trajectory data to obtain the compressed handwritten trajectory data comprises:
performing dimensional compression on the handwritten original trajectory data, to obtain the compressed handwritten trajectory data, a correlation between data of each dimension in the compressed handwritten trajectory data and a model recognition result of the handwriting recognition model being not lower than a predetermined threshold.

4. The method according to claim 1, wherein the handwriting recognition model is an end-to-end model.

5. The method according to claim 4, wherein the training of the handwriting recognition model comprises:
obtaining the training data set and a pre-selected training model corresponding to the training data set;
obtaining the handwritten trajectory data for each piece of training data in the training data set; and
training the pre-selected training model with the handwritten trajectory data for each piece of training data, to obtain the pre-selected training model that has been trained as the handwriting recognition model.

6. The method according to claim 5, wherein the obtaining the training data set comprises:
obtaining a historical handwritten trajectory data set, the historical handwritten trajectory data set comprising at least one of horizontal handwritten trajectory data, vertical handwritten trajectory data, overlapping handwritten trajectory data, and rotating handwritten trajectory data; and
performing data augmentation on handwritten data in the historical handwritten trajectory data set, and using the data-augmented historical handwritten trajectory data set as the training data set.

7. The method according to claim 6, wherein the training the pre-selected training model with the handwritten trajectory data of each piece of training data to obtain the handwriting recognition model comprises:
obtaining a difficult sample and an easy sample in each piece of training data; and
training the pre-selected training model in a mode of first training the difficult sample and then training the easy sample.

8. The method according to claim 7, wherein the training the pre-selected training model with the handwritten trajectory data of each piece of training data to obtain the handwriting recognition model comprises:
fine-tuning the pre-selected training model during a process of training the pre-selected model, and using the pre-selected training model that has been trained as the handwriting recognition model.

9. The method according to claim 5, wherein the method further comprises:
performing model distillation on the pre-selected training model that has been trained, to obtain the distillated pre-selected training model, and using the distillated pre-selected training model as the compressed handwriting recognition model.

10. A handwriting recognition apparatus, comprising:
a memory operable to store computer-readable instructions; and
a processor circuitry operable to read the computer-readable instructions, the processor circuitry when executing the computer-readable instructions is configured to:
obtain handwritten original trajectory data in real-time;
compress the handwritten original trajectory data, to obtain compressed handwritten trajectory data; and
input the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

11. The apparatus according to claim 10, wherein the processor circuitry is configured to:
perform data preprocessing on handwritten input data that is obtained in real-time, the data preprocessing comprising re-sampling; and
obtain the handwritten original trajectory data in real-time according to the preprocessed handwritten input data.

12. The apparatus according to claim 11, wherein the processor circuitry is configured to:
perform dimensional compression on the handwritten original trajectory data, to obtain the compressed handwritten trajectory data, a correlation between data of each dimension in the compressed handwritten trajectory data and a model recognition result of the handwriting recognition model being not lower than a predetermined threshold.

13. The apparatus according to claim 10, wherein the handwriting recognition model is an end-to-end model.

14. The apparatus according to claim 13, wherein the processor circuitry is configured to:
obtain the training data set and a pre-selected training model corresponding to the training data set;
obtain the handwritten trajectory data for each piece of training data in the training data set; and
train the pre-selected training model with the handwritten trajectory data for each piece of training data, to obtain the pre-selected training model that has been trained as the handwriting recognition model.

15. The apparatus according to claim 14, wherein the processor circuitry is configured to:
obtain a historical handwritten trajectory data set, the historical handwritten trajectory data set comprising at least one of horizontal handwritten trajectory data, vertical handwritten trajectory data, overlapping handwritten trajectory data, and rotating handwritten trajectory data; and
perform data augmentation on handwritten data in the historical handwritten trajectory data set, and use the data-augmented historical handwritten trajectory data set as the training data set.

16. The apparatus according to claim 15, wherein the processor circuitry is configured to:
obtain a difficult sample and an easy sample in each piece of training data; and
train the pre-selected training model in a mode of first training the difficult sample and then training the easy sample.

17. The apparatus according to claim 16, wherein the processor circuitry is configured to:
fine-tune the pre-selected training model during a process of training the pre-selected model, and use the pre-selected training model that has been trained as the handwriting recognition model.

18. The apparatus according to claim 14, wherein the processor circuitry is further configured to:
perform model distillation on the pre-selected training model that has been trained, to obtain the distillated pre-selected training model, and use the distillated pre-selected training model as the compressed handwriting recognition model.

19. A non-transitory machine-readable media, having instructions stored on the machine-readable media, the instructions configured to, when executed, cause a machine to:
obtain handwritten original trajectory data in real-time;
compress the handwritten original trajectory data, to obtain compressed handwritten trajectory data; and
input the compressed handwritten trajectory data into a compressed handwriting recognition model for recognition, to obtain a text recognition result corresponding to the handwritten original trajectory data, a handwriting recognition model being obtained by training with handwritten trajectory data of each piece of training data in a training data set, and the compressed handwriting recognition model being obtained by performing model compression on the handwriting recognition model.

20. The non-transitory machine-readable media according to claim 19, wherein the instructions are configured to cause the machine to:
perform data preprocessing on handwritten input data that is obtained in real-time, the data preprocessing comprising re-sampling; and
obtain the handwritten original trajectory data in real-time according to the preprocessed handwritten input data.
